(19) United States
(12) Patent Application Publication
(10) Pub. No.: US 2026/0238363 A1
(43) Pub. Date: Aug. 13, 2026

(54) Adapting a SINR Value for Link Adaptation

(71) Applicant: Telefonaktiebolaget LM Ericsson (publ), Stockholm (SE)

(72) Inventors: Christos Vranas, Stockholm (SE); Karl Werner, Segeltorp (SE); Rikke Apelfröjd, Knivsta (SE)

(21) Appl. No.: 19/155,450

(22) PCT Filed: Apr. 20, 2023
(86) PCT No.: PCT/SE2023/050361

§ 371 Date: Aug. 11, 2025

(30) Foreign Application Priority Data
Feb. 15, 2023 (GR) 20230100121

(51) Int. Cl. H04B 17/336; H04L 1/1812

(52) U.S. Cl. CPC H04B 17/336; H04L 1/1812

(57) ABSTRACT

It is provided a method for adapting an SINR value used for link adaptation. The method comprises: determining a retransmission delay between a transmission and a retransmission; obtaining a set of samples of SINR measurements for uplink transmissions; obtaining, for each SINR sample in the set of samples, associated retransmission SINR samples; defining a number of data bins for different ranges of SINR; calculating a combined SINR metric for each base SINR sample based on the base SINR sample and its associated retransmission SINR samples; allocating each of the combined SINR metrics to a data bin; determining a representative SINR value based on a reliability metric, resulting in a set of representative SINR values; obtaining a SINR measurement for an uplink transmission; obtaining the representative SINR value from a data bin; and providing an SINR value based on the representative SINR value to a link adaptation module.

### TECHNICAL FIELD

The present disclosure relates to the field signal-to-interference-plus-noise ratio (SINR) value used for link adaptation, and in particular to adapting such an SINR value

### BACKGROUND

In wireless communications, link adaptation is applied in order to find the appropriate transmission parameters, such as modulation order, code rate, rank and number of physical resource blocks (PRBs), e.g. depending on link quality estimates, estimates of the radio channel and power of interference and noise. Link adaptation is designed to meet performance requirements of the supported services, such as mobile broadband and services with strict latency, as well as reliability requirements, such as high-reliability-low-latency-communication (HRLLC). Especially, the latter requires a robust link adaptation (LA) in order to deliver data with a few hybrid automatic repeat request (HARQ) retransmission attempts and high reliability at the lowest possible cost in terms of throughput.

Channel estimates for uplink (UL) transmissions can be obtained using reference signals e.g., sounding reference signals (SRS), or demodulation reference signals (DMRS). Interference and noise power can be measured on resources where reference signals are transmitted, but also on other resources. These measurements can be expressed in an SINR value.

However, the interference and channel can vary rapidly due to multiple factors, such as fast changes in the on-off behaviour of the interferers and high user mobility. These conditions can create high uncertainty, or equivalently weak correlation between the estimated link quality and the link quality at transmission time, when link adaptation is applied. Particularly, the variation of the inter-cell interference power is one of the most critical problems, especially in UL, where the interference originates from multiple users in different locations in the neighbouring cells. Thus, if the rapid variations are combined with a high level of fluctuations in the link quality, overestimations and/or underestimations of the link quality at the transmission time may occur. Such estimation errors might be acceptable for mobile broadband where it is acceptable to have residual success probability of ~90% to ~99% and four transmission attempts, but this is not acceptable for HRLLC cases with high reliability, such as ~99% to ~99.99% and strict latency budget: 1-3 transmission attempts.

In link adaptation, the modulation and coding scheme (MCS) selection is based on SINR estimates, computed at the radio network node. SINR reflects both interference and channel variations at the time of measurement, making the prediction of the actual SINR conditions at the transmission time even more difficult. SINR overestimates can lead to the radio network node assigning too high, i.e. too optimistic MCS to the UE for the UL transmission, which increases transport block failures. In contrast, SINR underestimates can lead to sub-optimal usage of resources and less throughput than the channel permits.

In terms of SINR overestimates, in order to reach a reliability metric, e.g. in the form of a block error rate (BLER) target, a fixed backoff can be applied to the estimated SINR, which leads to more conservative MCS schemes. The backoff is an offset value that makes the SINR appear worse than its original estimate. However, the backoff negatively affects throughput, due to the more conservative link adaptation.

If rapid interference variations result in weak correlation between the link quality at the transmission time and the obsolete (no longer representative) link quality estimates used for selection of transport format, this can create many difficulties for the link adaptation. In case that the weak correlation, higher backoff is required, particularly for HRLLC services, in order to reach the reliability requirements. This results in high loss in terms of throughput, especially for stricter latency and reliability requirements.

### SUMMARY

One object is to improve link adaptation when SINR fluctuates.

According to a first aspect, it is provided a method for adapting a signal-to-interference-plus-noise ratio SINR value used for link adaptation. The method is performed by a SINR value adapter. The method comprises: determining a retransmission delay, in terms of number of samples, between a transmission and a retransmission in accordance with hybrid automatic repeat request, HARQ; obtaining a set of samples of SINR measurements for uplink transmissions; obtaining, for each SINR sample in the set of samples, denoted a base SINR sample, associated retransmission SINR samples corresponding to all possible retransmissions based on the retransmission delay, while complying with a maximum number of transmissions; defining a number of data bins for different ranges of SINR; calculating, for each base SINR sample in the set of samples, a combined SINR metric for each base SINR sample based on the base SINR sample and its associated retransmission SINR samples; allocating each of the combined SINR metrics to a data bin corresponding to the value of the base SINR sample; determining, for each data bin, a representative SINR value based on a reliability metric, resulting in a set of representative SINR values; obtaining a SINR measurement for an uplink transmission; obtaining the representative SINR value from a data bin that corresponds to the SINR measurement; and providing an SINR value based on the representative SINR value to a link adaptation module.

The determining a representative SINR value may comprise, for each data bin, determining a representative SINR value such that a probability, defined as a probability of a combined SINR metric in the data bin being less than the representative value, is less than a reliability metric.

The reliability metric may be based on a block error rate.

The reliability metric may be defined as a percentile from a distribution calculated by all the combined SINR metrics of the data bin in question.

The determining representative SINR values may be repeated for a plurality of different values of the reliability metric, resulting in multiple sets of representative SINR values, respectively associated with a reliability metric value.

The obtaining a set of samples, the obtaining associated retransmission SINR samples, calculating a combined SINR, defining number of data bins, allocating each of the combined SINR metrics and determining representative SINR values may be repeated for a plurality of different sets of samples for different periods of time, resulting in multiple sets of representative SINR values, respectively associated with a period of time.

The obtaining associated retransmission SINR samples, calculating a combined SINR, defining number of data bins, allocating each of the combined SINR metrics and determining representative SINR values may be repeated for a plurality of different values of maximum number of transmissions, resulting in multiple sets of representative SINR values, respectively associated with a maximum number of transmissions.

The associated retransmission SINR samples, calculating a combined SINR, defining number of data bins, allocating each of the combined SINR metrics and representative SINR values may be repeated for a plurality of different values of allocated bandwidth, resulting in multiple sets of representative SINR values, respectively associated with an allocated bandwidth.

According to a second aspect, it is provided a SINR value adapter for adapting a signal-to-interference-plus-noise ratio SINR value used for link adaptation. The SINR value adapter comprises: a processor; and a memory storing instructions that, when executed by the processor, cause the SINR value adapter to: determine a retransmission delay, in terms of number of samples, between a transmission and a retransmission in accordance with hybrid automatic repeat request, HARQ; obtain a set of samples of SINR measurements for uplink transmissions; obtain, for each SINR sample in the set of samples, denoted a base SINR sample, associated retransmission SINR samples corresponding to all possible retransmissions based on the retransmission delay, while complying with a maximum number of transmissions; define a number of data bins for different ranges of SINR; calculate, for each base SINR sample in the set of samples, a combined SINR metric for each base SINR sample based on the base SINR sample and its associated retransmission SINR samples; allocate each of the combined SINR metrics to a data bin corresponding to the value of the base SINR sample; determine, for each data bin, a representative SINR value based on a reliability metric, resulting in a set of representative SINR values; obtain a SINR measurement for an uplink transmission; obtain the representative SINR value from a data bin that corresponds to the SINR measurement; and provide an SINR value based on the representative SINR value to a link adaptation module.

The instructions to determine a representative SINR value may comprise instructions that, when executed by the processor, cause the SINR value adapter to, for each data bin, determine a representative SINR value such that a probability, defined as a probability of a combined SINR metric in the data bin being less than the representative value, is less than a reliability metric.

The reliability metric may be based on a block error rate.

The reliability metric may be defined as a percentile from a distribution calculated by all the combined SINR metrics of the data bin in question.

The instructions to determine representative SINR values may be repeated for a plurality of different values of the reliability metric, resulting in multiple sets of representative SINR values, respectively associated with a reliability metric value.

The SINR value adapter may further comprise instructions that, when executed by the processor, cause the SINR value adapter to repeat the instructions to obtain a set of samples, obtain associated retransmission SINR samples, calculate a combined SINR, define number of data bins, allocate each of the combined SINR metrics and determine representative SINR values, for a plurality of different sets of samples for different periods of time, resulting in multiple sets of representative SINR values, respectively associated with a period of time.

The SINR value adapter may further comprise instructions that, when executed by the processor, cause the SINR value adapter to repeat the instructions to obtain associated retransmission SINR samples, calculate a combined SINR, define number of data bins, allocate each of the combined SINR metrics and determine representative SINR values, for a plurality of different values of maximum number of transmissions, resulting in multiple sets of representative SINR values, respectively associated with a maximum number of transmissions.

The SINR value adapter may further comprise instructions that, when executed by the processor, cause the SINR value adapter to repeat the instructions to obtain associated retransmission SINR samples, calculate a combined SINR, define number of data bins, allocate each of the combined SINR metrics and determine representative SINR values, for a plurality of different values of allocated bandwidth, resulting in multiple sets of representative SINR values, respectively associated with an allocated bandwidth.

According to a third aspect, it is provided a computer program for adapting a signal-to-interference-plus-noise ratio SINR value used for link adaptation. The computer program comprises computer program code which, when executed on a SINR value adapter causes the SINR value adapter to: determine a retransmission delay, in terms of number of samples, between a transmission and a retransmission in accordance with hybrid automatic repeat request, HARQ; obtain a set of samples of SINR measurements for uplink transmissions; obtain, for each SINR sample in the set of samples, denoted a base SINR sample, associated retransmission SINR samples corresponding to all possible retransmissions based on the retransmission delay, while complying with a maximum number of transmissions; define a number of data bins for different ranges of SINR; calculate, for each base SINR sample in the set of samples, a combined SINR metric for each base SINR sample based on the base SINR sample and its associated retransmission SINR samples; allocate each of the combined SINR metrics to a data bin corresponding to the value of the base SINR sample; determine, for each data bin, a representative SINR value based on a reliability metric, resulting in a set of representative SINR values; obtain a SINR measurement for an uplink transmission; obtain the representative SINR value from a data bin that corresponds to the SINR measurement; and provide an SINR value based on the representative SINR value to a link adaptation module.

According to a fourth aspect, it is provided a computer program product comprising a computer program according to the third aspect and a computer readable means comprising non-transitory memory in which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram illustrating a cellular communication network 8 where embodiments presented herein may be applied;

FIG. 2 is a schematic graph illustrating a scenario where interference varies over time;

FIG. 3 is a schematic graph illustrating how embodiments presented herein perform in relation to prior art solutions;

FIGS. 4A-D are schematic diagrams illustrating embodiments of where the SINR value adapter can be implemented;

FIGS. 5A-C are flow charts illustrating embodiments of methods for adapting a SINR value used for link adaptation;

FIG. 6 is a schematic diagram illustrating components of the SINR value adapter of FIGS. 4A-D;

FIG. 7 is a schematic diagram showing functional modules of the SINR value adapter of FIG. 6 according to one embodiment; and

FIG. 8 shows one example of a computer program product comprising computer readable means.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

Embodiments presented herein exploit the use of historical SINR estimates to compute representative SINR values that reflect SINR variations throughout the full retransmission cycle of a packet. When the real-time SINR measurements come in, the representative SINR values are used to adjust the SINR measurement for a more representative link adaptation, to select uplink transmission parameters which can meet reliability constraints within a given latency budget.

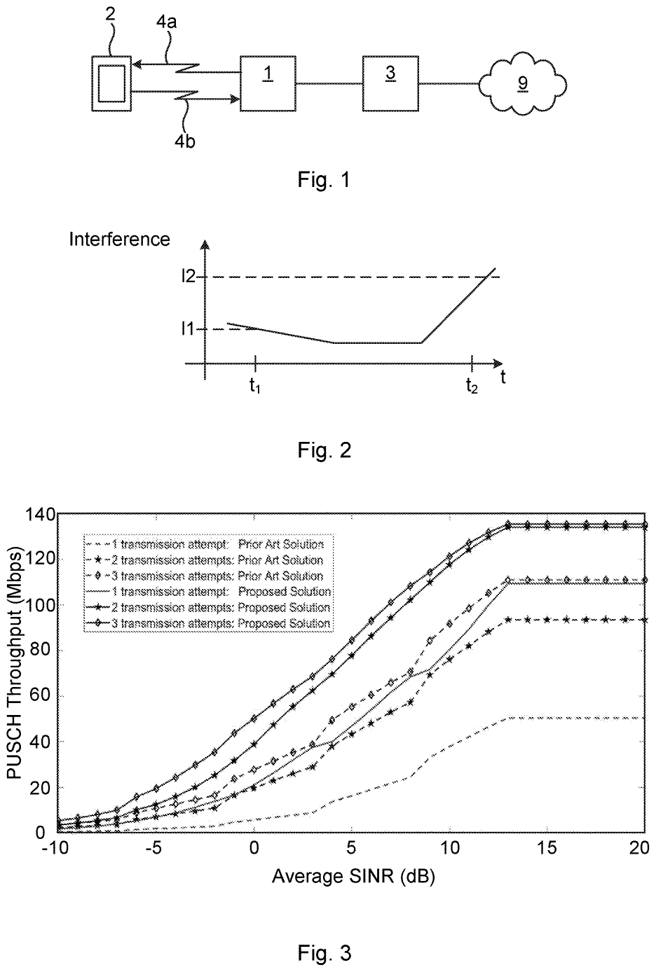

FIG. 1 is a schematic diagram illustrating a cellular communication network 8 where embodiments presented herein may be applied. The cellular communication network 8 comprises a core network 3 and one or more radio network nodes 1, here in the form of radio base stations being evolved Node Bs, also known as eNode Bs or eNBs. The radio network node 1 could also be in the form of g Node Bs, Node Bs, BTSs (Base Transceiver Stations) and/or BSSs (Base Station Subsystems), etc. The radio network node 1 provides radio connectivity over a wireless interface 4a-b to one or more instances of user equipment (UE) 2. The term UE 2 is also known as mobile communication terminal, wireless device, mobile terminal, user terminal, user agent, wireless terminal, machine-to-machine device etc. and can be, for example, what today are commonly known as a mobile phone, smart phone or a tablet/laptop with wireless connectivity.

The cellular communication network 8 may e.g. comply with any one or a combination of 5G NR (New Radio), LTE (Long Term Evolution), LTE Advanced, W-CDMA (Wideband Code Division Multiplex), EDGE (Enhanced Data Rates for GSM (Global System for Mobile communication) Evolution), GPRS (General Packet Radio Service), CDMA2000 (Code Division Multiple Access 2000), or any other current or future wireless network, as long as the principles described hereinafter are applicable.

Over the wireless interface, downlink (DL) communication 4a occurs from the radio network node 1 to the UE 2 and uplink (UL) communication 4b occurs from the UE 2 to the radio network node 1. The quality of the wireless radio interface to each UE 2 can vary over time and depending on the position of the UE 2, due to effects such as fading, multipath propagation, interference, etc.

The radio network node 1 is also connected to the core network 3 for connectivity to central functions and a wide area network 7, such as the Internet.

Channel estimates for UL transmissions 4b can be obtained by the radio network node 1 based on reference signals from the UE. The reference signal can e.g. be sounding reference signals (SRS), or demodulation reference signals (DMRS). Interference and noise power can be measured on resources where reference signals are transmitted, but also on other resources. This allows an SINR to be estimated for each the UL channel 4b for each UE 2. The SINR is one input to link adaptation, where transmission characteristic, such as MCS, rank, etc. are adjusted to achieve a balance between throughput and reliability. A similar procedure is applied for the DL channel 4a.

As known in the art per se, HARQ is used to control retransmissions if a received transmission is not decoded correctly.

FIG. 2 is a schematic graph illustrating a scenario where interference varies over time. The line in FIG. 2 illustrates interference level over time. An issue occurs for link adaptation based on SINR when interference fluctuates. UL SINR can be evaluated at time t1, when interference is at level I1. At time t2, the link adaptation occurs based on the measured SINR, when the interference was at level I1. However, at time t2, the interference has increased to level 12. Hence the link adaptation layer is based on an underestimation of interference, i.e. an overestimation of the link quality. If this is not addressed, this will lead to an overoptimistic link adaptation, where reliability targets are likely to be missed, especially for limited number of retransmissions.

As explained in more detail below, embodiments presented herein are based on evaluating a set of historical SINR measurements to obtain representative SINR values. These representative SINR values are saved, and when realtime SINR measurements arrive, a representative SINR value is found to arrive at a SINR value that better reflects the real SINR value at the time of link adaptation with a certain probability.

FIG. 3 is a schematic graph illustrating how embodiments presented herein perform in relation to prior art solutions. The graph has been obtained through simulations to illustrate the performance of embodiments presented herein. It is seen how embodiments presented herein perform significantly better for each one of three cases, first transmission attempt, second transmission attempt and third transmission attempt. The prior art solution is based on applying a fixed backoff to the SINR estimate, the backoff being chosen to meet reliability constraints.

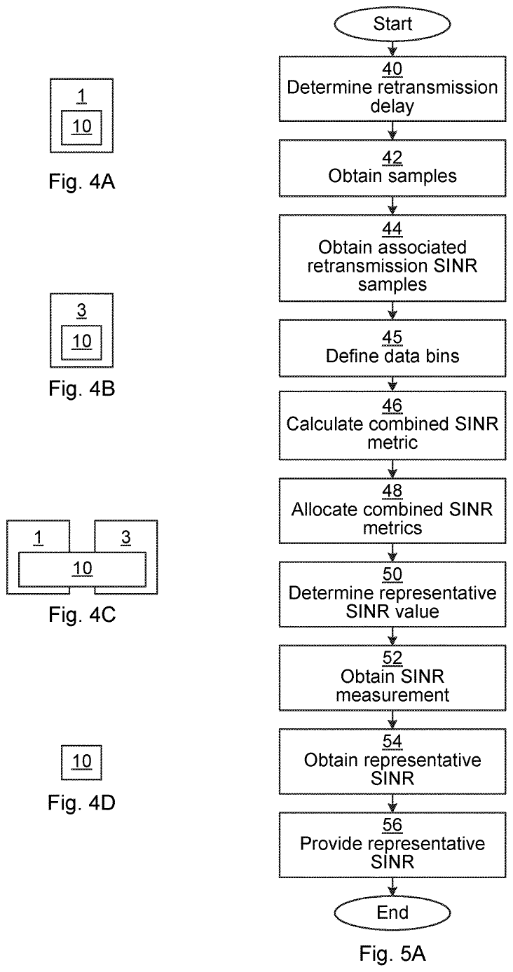

FIGS. 4A-D are schematic diagrams illustrating embodiments of where the SINR value adapter 10 can be implemented.

In FIG. 4A, the SINR value adapter 10 shown implemented in the radio network node 1. The radio network node 1 is thus the host device for the SINR value adapter 10 in this implementation.

In FIG. 4B, the SINR value adapter 10 shown implemented in the core network 3. An entity in the core network 3 can thus be the host device for the SINR value adapter 10 in this implementation.

In FIG. 4C, the SINR value adapter 10 shown implemented partly in the core network 3 and partly in the radio network node 1. An entity in the core network 3 and the radio network node 1 are thus both host devices for (potentially different parts of) the SINR value adapter 10 in this implementation.

In FIG. 4D, the SINR value adapter 10 is shown as implemented as a stand-alone device. The SINR value adapter 10 thus does not have a host device in this implementation. The SINR value adapter 10 can be located locally to the radio network node 1 or remotely from the radio network node 1, also known as in the cloud.

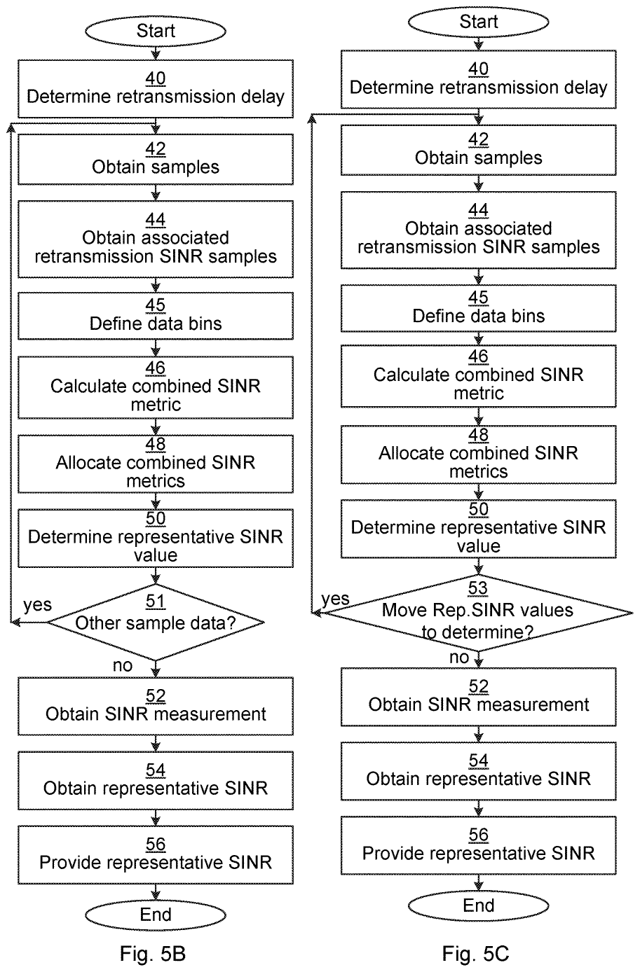

FIGS. 5A-C are flow charts illustrating embodiments of methods for adapting a SINR value used for link adaptation. The method being performed by a SINR value adapter 10.

In a determine retransmission delay step 40, SINR value adapter 10 determines a retransmission delay, in terms of number of samples, between a transmission and a retransmission in accordance with HARQ. Samples can be any suitable regular time period, e.g. slots, subframes, TTIs (transmission time intervals), milliseconds, etc. The retransmission delay is thus a delay between two transmission attempts (in accordance with HARQ retransmissions) for the same data, and can be considered a HARQ roundtrip time. The retransmission delay could potentially vary depending on processing delays to the radio network node 1 and delay from the radio network node 1 to provide feedback to the UE 2 for the UE 2 to proceed with the next transmission. Nevertheless, in this step, the retransmission delay is determined as a fixed value, e.g. based on an average of real retransmissions. For purposes herein, the same retransmission delay is used for any two subsequent transmissions, e.g. between the original transmission (first transmission) and the first retransmission (second transmission), as well as between the first retransmission (second transmission) and the second retransmission (third transmission).

In an obtain samples step 42, the SINR value adapter 10 obtains a set of samples of SINR measurements for uplink transmissions. The SINR measurements can be historical SINR data for UL transmissions. It has been found that even though this data may be historical, the resulting representative SINR value (see below) is still valuable and provides real benefit, as shown in FIG. 3 and explained above.

The set of samples of SINR measurements can be derived by combining noise/interference level estimates with signal power estimates. In some embodiments, the combined noise/interference levels and the signal power estimates are derived in different samples. The noise/interference levels and the signal power estimates may be derived from reference signals (e.g. PUSCH (physical uplink shared channel) DMRS, or SRS).

The interference/noise power traces and the signal power traces may be concatenated from multiple samples. In some embodiments, interference estimates are concatenated from a first set of samples which are scheduled with a first set of UEs, and a second set of samples which are scheduled with a second set of UEs. The first and the second set of UEs may be different. In other words, the interference trace does not need to be specific to the UE for which link adaptation is to be done.

The interference trace may be radio network node specific. The interference traces may be derived based on time-of-day, load point in the network or similar.

In an obtain associated retransmission SINR samples step 44, the SINR value adapter 10 obtains, for each SINR sample in the set of samples, denoted a base SINR sample SINRₙ, associated retransmission SINR samples corresponding to all possible retransmissions based on the retransmission delay, while complying with a maximum number of transmissions. For instance, if the base sample is at time n, the retransmission delay is d (in same time unit as n (e.g. samples)), and the maximum number of retransmission attempts K is 3, then there can be a maximum of three retransmission attempts. Retransmission SINR samples are thereby obtained for times n+d, n+2*d and n+3*d. In the following, these retransmission times are referred to in subscripts as n+d, n+2d, n+3d, etc., while the base transmission occurs at time n.

In define data bins step 45, the SINR value adapter 10 defines a number of data bins for different ranges of SINR. The data bins are defined based on the SINR samples. For examples herein, M bins are defined for different ranges of SINR. Each data bin m, 0<m<=M, can hold a respective data set Dₘ.

In a calculate combined SINR metric step 46, the SINR value adapter 10 calculates, for each base SINR sample n in the set of samples, a combined SINR metric Wₙ is calculated for each base SINR sample n. The combined SINR metric Wn is calculated based on the base SINR sample n and its associated retransmission SINR samples obtained in the preceding step.

Hence, the combined SINR metric Wn is calculated for all the transmission attempts associated with a reference signal arriving at sample n based on retransmission SINR samples SINR_{n+d}, SINR_{n+2d}, . . . , SINR_{n+Kd}, at the (re)transmission time points. One example of how the SINR metric Wn can be calculated follows in equation (1):

$${W}_{n} = {2}^{( {\sum }_{k = 0}^{K} {log}_{2} ( 1 + {SINR}_{n + d\_k} ) )} - 1 \qquad ( 1 )$$

In Equation (1), the SINR value index has been generalised in that it is related to a sample n+d_k, i.e. that the retransmission delay d_k depends on k, where one possible implementation is that the index n+d_k=n+kd, but other variants are possible. One such variant is retransmission bursts, in which a packet is retransmitted multiple times without waiting for a second NACK. Equation (1) is just an example to calculate the combined SINR metric. Other examples for calculating Wn follows hereinafter in equations (2), (3) and (4):

$$Wn = max\_k ( {SINR}_{n + kd} ) \qquad ( 2 )$$

$$Wn = {\sum }_{k = 0}^{K} {SINR}_{n + d\_k} \qquad ( 3 )$$

$$Wn = {log}_{10} ( {\sum }_{k = 0}^{K} {10}^{{SINR}_{n + d\_k}} ) \qquad ( 4 )$$

### Yet Another Example Follows in Equation (5):

$$Wn = {f}^{- 1} ( {\sum }_{k = 0}^{K} f ( {SINR}_{n + {d}_{k}} ) \qquad ( 5 )$$

where f(SINR) is a function that maps the SINR to the expected rate (it could be a look-up table) and f⁻¹( ) is the inverse of f( ) A special case of Equation (5) is Equation (1).

In general, the combined SINR metric Wn is a function of the SINR over multiple occasions, representing the (re)transmission instances.

In an allocate combined SINR metrics step 48, the SINR value adapter 10 allocates each of the combined SINR metrics Wn to a data bin corresponding to the value of the base SINR sample. In other words, for each measurement time point n, the corresponding Wn is added to the to Dₘ for which the base SINR sample SINRₙ, falls within the range of Dₘ.

In a determine representative SINR value step 50, the SINR value adapter 10 determines, for each data bin m, a representative SINR value based on a reliability metric, resulting in a set comprising at least one representative SINR values SINRᵣₑₚ, per data bin m.

In one embodiment, the reliability metric is defined as a percentile from a distribution calculated by all the combined SINR metrics of the data bin m in question.

In one embodiment, the representative SINR value, for each data bin m, is determines such that a probability, defined as a probability of a combined SINR metric in the data bin m being less than the representative value, is less than a reliability metric.

The determine representative SINR value step 50 may be repeated for a plurality of different values of the reliability metric, resulting in multiple sets of representative SINR values SINRᵣₑₚ, respectively associated with a reliability metric value.

The reliability metric can be based on a BLER value. The BLER value is based on the original transmission and all (if any) retransmissions in accordance with the maximum number of transmissions K. Hence, in some embodiments, multiple representative SINR values SINRᵣₑₚ per data bin m are computed, to reflect different BLER/latency requirements, and the lowest of those representative SINR values SINRᵣₑₚ are used in the subsequent processing. This is useful for meeting a constraint of the BLER for first transmission and BLER for the last transmission.

A more detailed example for the determine representative SINR value step 50 will now be provided. For the data set Dₘ of each data bin m, define at least one maximal SINRᵣₑₚ such that Pr(W≤SINRᵣₑₚ|W∈Dₘ)≤γ, where γ is a reliability metric, such as the BLER target or a value that ensures a BLER target based on offline-evaluations or post BLER measurements, and Pr denotes probability. γ could reflect on a percentile from the cumulative distribution calculated by all the Wₙ (1) which belong to the Dₘ interval. In other words: this step involves determining a level for the representative SINR value SINRᵣₑₚ such that it is unlikely to be higher than the actual representative SINR value.

It is to be noted that the representative SINR value can be stored as an absolute SINR value, that can be used for link adaptation directly, or as a positive or negative offset, that is to be added to any SINR measurement (see below).

At this point all representative SINR values has been calculated and are available to be used when SINR measurements arrive. Processing after this can occur at a later stage, and all the samples upon which the representative SINR value were calculated are not needed for subsequent processing. Hence, optionally, the SINR samples are discarded prior to the subsequent obtain SINR measurement step 52 to reduce memory requirements.

In the obtain SINR measurement step 52, the SINR value adapter 10 obtains a SINR measurement for an uplink transmission. The SINR measurement can be a real-time SINR measurement. This is a SINR measurement that is used as input, which is to be adapted based on embodiments presented herein.

In an obtain representative SINR value step 54, the SINR value adapter 10 obtains the representative SINR value from a data bin m that corresponds to (i.e. has a range that encompasses) the SINR measurement. It is to be noted that a selection of the representative SINR value can also be based on additional factors, such as maximum number of transmissions K, reliability metric γ, time of day (see below), allocated bandwidth, etc.

In a provide representative SINR step 56, the SINR value adapter 10 provides an SINR value based on the representative SINR value to a link adaptation module. The SINR value can be the representative SINR value itself (when calculated as an absolute SINR value) or an SINR value calculated by adding the representative SINR value (as an offset) to the SINR measurement. Hence, the SINR is adapted based on the representative SINR value for further link adaptation, such as selecting MCS, rank, etc.

Looking now to FIG. 5B, only new or modified steps compared to FIG. 5A will be described.

In an optional conditional other sample data step 51, the SINR value adapter 10 determines whether there are samples for additional periods of time that need to be processed for obtaining a new set of representative SINR values SINRᵣₑₚ. If this is the case, the method returns to the obtain samples step 42, to obtain samples for the additional period of time. Each iteration results in an additional set of representative SINR values SINRᵣₑₚ, associated with the additional period of time. When there are no more samples for additional periods of time that need to be processed, the method proceeds to the obtain SINR measurement step 52. In this way, there are different instances of the representative SINR values SINRᵣₑₚ that are determined for different periods of time, e.g. time of day, day of week, etc., since the interference environment can be more similar for corresponding periods of time.

Looking now to FIG. 5C, only new or modified steps compared to FIG. 5A will be described.

In an optional conditional more representative SINR values to determine step 53, the SINR value adapter 10 determines whether there are more representative SINR values to determine. This can be due to more values of maximum number of transmissions, for which a set of representative SINR values should be determined. Alternatively, there can be more values of allocated bandwidth for which a set of representative SINR values should be determined. When more representative SINR value are to be determined, the method returns to the obtain associated retransmission SINR samples step 44. Otherwise, the method proceeds to the obtain SINR measurement step 52. In this way, there are different instances of the representative SINR values SINRᵣₑₚ that are determined for different values of maximum number of transmissions K, or allocated bandwidths, since the interference environment can be more similar for corresponding values of maximum number of transmissions K, or allocated bandwidths.

Embodiments presented herein are able to capture variations (over time) in the SINR and select a transmission format that balances spectral efficiency with the required reliability within the retransmission time budget. This allows running services that require strictly bounded latency while keeping a favourable spectral efficiency. The solution relies on inherent structures of the radio access network and has been proven to result in significant performance gains.

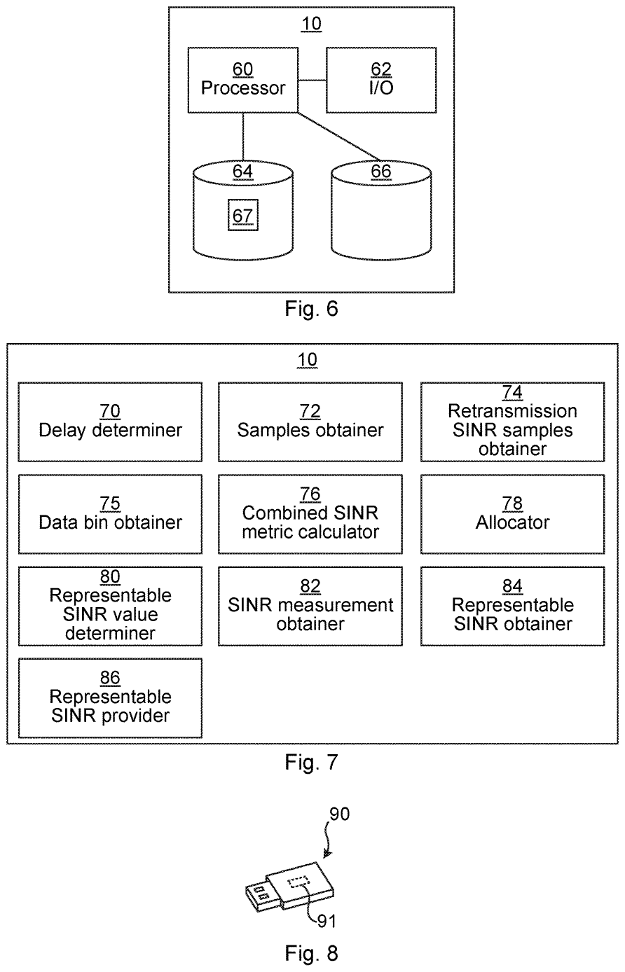

FIG. 6 is a schematic diagram illustrating components of the SINR value adapter 10 of FIGS. 4A-D. It is to be noted that when the SINR value adapter 10 is implemented in a host device, one or more of the mentioned components can be shared with the host device. A processor 60 is provided using any combination of one or more of a suitable central processing unit (CPU), graphics processing unit (GPU), multiprocessor, neural processing unit (NPU), microcontroller, digital signal processor (DSP), etc., capable of executing software instructions 67 stored in a memory 64, which can thus be a computer program product. The processor 60 could alternatively be implemented using an application specific integrated circuit (ASIC), field programmable gate array (FPGA), etc. The processor 60 can be configured to execute the method described with reference to FIG. 5 above.

The memory 64 can be any combination of random-access memory (RAM) and/or read-only memory (ROM). The memory 64 also comprises non-transitory persistent storage, which, for example, can be any single one or combination of magnetic memory, optical memory, solid-state memory or even remotely mounted memory.

A data memory 66 is also provided for reading and/or storing data during execution of software instructions in the processor 60. The data memory 66 can be any combination of RAM and/or ROM.

The SINR value adapter 10 further comprises an I/O interface 62 for communicating with external and/or internal entities.

An I/O interface 62 is provided for communicating with external and/or internal entities using wired communication, e.g. based on Ethernet, and/or wireless communication, e.g. Wi-Fi, and/or a cellular network, complying with any one or a combination of sixth generation (6G) mobile networks, next generation mobile networks (fifth generation, 5G), LTE (Long Term Evolution), UMTS (Universal Mobile Telecommunications System) utilising W-CDMA (Wideband Code Division Multiplex), or any other current or future wireless network, as long as the principles described hereinafter are applicable.

Other components of the SINR value adapter 10 are omitted in order not to obscure the concepts presented herein.

FIG. 7 is a schematic diagram showing functional modules of the SINR value adapter 10 of FIG. 6 according to one embodiment. The modules are implemented using software instructions such as a computer program executing in the SINR value adapter 10. Alternatively or additionally, the modules are implemented using hardware, such as any one or more of an ASIC (Application Specific Integrated Circuit), an FPGA (Field Programmable Gate Array), or discrete logical circuits. The modules correspond to the steps in embodiments of the methods illustrated in FIG. 5.

A delay determiner 70 corresponds to step 40. A samples obtainer 72 corresponds to step 42. A retransmission SINR samples obtainer 74 corresponds to step 44. A data bin definer 75 corresponds to step 45. A combined SINR metric calculator step 76 corresponds to step 46. An allocator 78 corresponds to step 48. A representative SINR value determiner 80 corresponds to step 50. A SINR measurement obtainer 82 corresponds to step 52. A representative SINR obtainer 84 corresponds to step 54. A representative SINR provider 86 corresponds to step 56.

FIG. 8 shows one example of a computer program product 90 comprising computer readable means. On this computer readable means, a computer program 91 can be stored in a non-transitory memory. The computer program can cause a processor to execute a method according to embodiments described herein. In this example, the computer program product is in the form of a removable solid-state memory, e.g. a Universal Serial Bus (USB) drive. As explained above, the computer program product could also be embodied in a memory of a device, such as the computer program product 64 of FIG. 6. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1-18. (canceled)

19. A method for adapting a signal-to-interference-plus-noise ratio (SINR) value used for link adaptation, the method being performed by a SINR value adapter, the method comprising:
determining a retransmission delay, in terms of number of samples, between a transmission and a retransmission in accordance with hybrid automatic repeat request (HARQ);
obtaining a set of samples of SINR measurements for uplink transmissions;
obtaining, for each SINR sample in the set of samples, denoted a base SINR sample, associated retransmission SINR samples corresponding to all possible retransmissions based on the retransmission delay, while complying with a maximum number of transmissions;
defining a number of data bins for different ranges of SINR;
calculating, for each base SINR sample in the set of samples, a combined SINR metric for each base SINR sample based on the base SINR sample and its associated retransmission SINR samples;
allocating each of the combined SINR metrics to a data bin corresponding to the value of the base SINR sample;
determining, for each data bin, a representative SINR value based on a reliability metric, resulting in a set of representative SINR values;
obtaining a SINR measurement for an uplink transmission;
obtaining the representative SINR value from a data bin that corresponds to the SINR measurement; and
providing an SINR value based on the representative SINR value to a link adaptation module.

20. The method of claim 19, wherein the determining a representative SINR value comprises, for each data bin, determining a representative SINR value such that a probability, defined as a probability of a combined SINR metric in the data bin being less than the representative value, is less than a reliability metric.

21. The method of claim 19, wherein the reliability metric is based on a block error rate.

22. The method of claim 19, wherein the reliability metric is defined as a percentile from a distribution calculated by all the combined SINR metrics of the data bin in question.

23. The method of claim 19, wherein the determining representative SINR values is repeated for a plurality of different values of the reliability metric, resulting in multiple sets of representative SINR values, respectively associated with a reliability metric value.

24. The method of claim 19, wherein the obtaining a set of samples, the obtaining associated retransmission SINR samples, calculating a combined SINR, defining number of data bins, allocating each of the combined SINR metrics and determining representative SINR values are repeated for a plurality of different sets of samples for different periods of time, resulting in multiple sets of representative SINR values, respectively associated with a period of time.

25. The method of claim 19, wherein the obtaining associated retransmission SINR samples, calculating a combined SINR, defining number of data bins, allocating each of the combined SINR metrics and determining representative SINR values are repeated for a plurality of different values of maximum number of transmissions, resulting in multiple sets of representative SINR values, respectively associated with a maximum number of transmissions.

26. The method of claim 19, wherein the obtaining associated retransmission SINR samples, calculating a combined SINR, defining number of data bins, allocating each of the combined SINR metrics and determining representative SINR values are repeated for a plurality of different values of allocated bandwidth, resulting in multiple sets of representative SINR values, respectively associated with an allocated bandwidth.

27. A SINR value adapter for adapting a signal-to-interference-plus-noise ratio (SINR) value used for link adaptation, the SINR value adapter comprising:
a processor; and
a memory storing instructions that, when executed by the processor, cause the SINR value adapter to:
determine a retransmission delay, in terms of number of samples, between a transmission and a retransmission in accordance with hybrid automatic repeat request (HARQ);
obtain a set of samples of SINR measurements for uplink transmissions;
obtain, for each SINR sample in the set of samples, denoted a base SINR sample, associated retransmission SINR samples corresponding to all possible retransmissions based on the retransmission delay, while complying with a maximum number of transmissions;
define a number of data bins for different ranges of SINR;
calculate, for each base SINR sample in the set of samples, a combined SINR metric for each base SINR sample based on the base SINR sample and its associated retransmission SINR samples;
allocate each of the combined SINR metrics to a data bin corresponding to the value of the base SINR sample;
determine, for each data bin, a representative SINR value based on a reliability metric, resulting in a set of representative SINR values;
obtain a SINR measurement for an uplink transmission;
obtain the representative SINR value from a data bin that corresponds to the SINR measurement; and
provide an SINR value based on the representative SINR value to a link adaptation module.

28. The SINR value adapter of claim 27, wherein the instructions to determine a representative SINR value comprise instructions that, when executed by the processor, cause the SINR value adapter to, for each data bin, determine a representative SINR value such that a probability, defined as a probability of a combined SINR metric in the data bin being less than the representative value, is less than a reliability metric.

29. The SINR value adapter of claim 27, wherein the reliability metric is based on a block error rate.

30. The SINR value adapter of claim 27, wherein the reliability metric is defined as a percentile from a distribution calculated by all the combined SINR metrics of the data bin in question.

31. The SINR value adapter of claim 27, wherein the instructions to determine representative SINR values is repeated for a plurality of different values of the reliability metric, resulting in multiple sets of representative SINR values, respectively associated with a reliability metric value.

32. The SINR value adapter of claim 27, further comprising instructions that, when executed by the processor, cause the SINR value adapter to repeat the instructions to obtain a set of samples, obtain associated retransmission SINR samples, calculate a combined SINR, define number of data bins, allocate each of the combined SINR metrics and determine representative SINR values, for a plurality of different sets of samples for different periods of time, resulting in multiple sets of representative SINR values, respectively associated with a period of time.

33. The SINR value adapter of claim 27, further comprising instructions that, when executed by the processor, cause the SINR value adapter to repeat the instructions to obtain associated retransmission SINR samples, calculate a combined SINR, define number of data bins, allocate each of the combined SINR metrics and determine representative SINR values, for a plurality of different values of maximum number of transmissions, resulting in multiple sets of representative SINR values, respectively associated with a maximum number of transmissions.

34. The SINR value adapter of claim 27, further comprising instructions that, when executed by the processor, cause the SINR value adapter to repeat the instructions to obtain associated retransmission SINR samples, calculate a combined SINR, define number of data bins, allocate each of the combined SINR metrics and determine representative SINR values, for a plurality of different values of allocated bandwidth, resulting in multiple sets of representative SINR values, respectively associated with an allocated bandwidth.

35. A non-transitory computer-readable medium comprising, stored thereupon, a computer program for adapting a signal-to-interference-plus-noise ratio (SINR) value used for link adaptation, the computer program comprising computer program code which, when executed on a SINR value adapter causes the SINR value adapter to:
determine a retransmission delay, in terms of number of samples, between a transmission and a retransmission in accordance with hybrid automatic repeat request (HARQ);
obtain a set of samples of SINR measurements for uplink transmissions;
obtain, for each SINR sample in the set of samples, denoted a base SINR sample, associated retransmission SINR samples corresponding to all possible retransmissions based on the retransmission delay, while complying with a maximum number of transmissions;
define a number of data bins for different ranges of SINR;
calculate, for each base SINR sample in the set of samples, a combined SINR metric for each base SINR sample based on the base SINR sample and its associated retransmission SINR samples;
allocate each of the combined SINR metrics to a data bin corresponding to the value of the base SINR sample;
determine, for each data bin, a representative SINR value based on a reliability metric, resulting in a set of representative SINR values;
obtain a SINR measurement for an uplink transmission;
obtain the representative SINR value from a data bin that corresponds to the SINR measurement; and
provide an SINR value based on the representative SINR value to a link adaptation module.
